(19) United States
(12) Patent Application Publication
(10) Pub. No.: US 2024/0218201 A1
(43) Pub. Date: Jul. 4, 2024

(54) COATING AGENT AND OIL-RESISTANT PAPER

(71) Applicant: Mitsubishi Chemical Corporation, Tokyo (JP)

(72) Inventors: Chizuko FURO, Tokyo (JP); Mayuka KURODA, Tokyo (JP)

(73) Assignee: Mitsubishi Chemical Corporation, Tokyo (JP)

(21) Appl. No.: 18/371,684

(22) Filed: Sep. 22, 2023

Related U.S. Application Data
(63) Continuation of application No. PCT/JP2022/013984, filed on Mar. 24, 2022.

(30) Foreign Application Priority Data
Mar. 25, 2021 (JP) 2021-052050

(51) Int. Cl. C09D 103/04; C09D 5/16; C09D 7/65; D21H 19/12; D21H 21/16

(52) U.S. Cl. CPC C09D 103/04; C09D 5/1668; C09D 7/65; D21H 19/12; D21H 21/16

(57) ABSTRACT

A coating agent is disclosed containing a carboxy group-containing polyvinyl alcohol-based resin, a crosslinking agent, and a modified starch. Also disclosed is an oil-resistant paper including a layer containing the coating agent.

### TECHNICAL FIELD

The present invention relates to a coating agent that can impart oil resistance and water resistance to a packaging material used for packaging a material to be packaged such as foods containing an oil and fat component, and an oil-resistant paper including at least one layer containing such a coating agent.

### BACKGROUND ART

As a packaging material for a food containing an oil and fat component, such as hamburgers, french fries, and fried chicken, a paper to which oil resistance is imparted on parts that come into contact with the food is generally used in order to repel the oil and fat component in the food and prevent the oil and fat component from seeping into surfaces that are not in contact with the food. An example of a method for imparting the oil resistance to the paper is a method of providing a coating layer made of a fluorine-based oil-resistant agent on the paper surface.

However, it has been revealed that an oil-resistant paper using such a fluorine-based oil-resistant agent generates a fluorine compound such as hydrogen fluoride, carbonyl fluoride, and hydrofluoric acid from the oil-resistant agent under high-temperature conditions, and when the oil-resistant paper is used in food packaging, harmful fluorine compounds may be generated during cooking or discarding and incineration after use, resulting in safety and environmental problems.

In view of such problems, various oil-resistant papers using a polyvinyl alcohol-based compound instead of the fluorine-based oil-resistant agent have been developed.

For example, Patent Literature 1 discloses an oil-resistant packaging material having moisture permeability, in which a layer of 1 g/m² to 8 g/m², which treated with a polyvinyl alcohol having a degree of saponification of 85% to 100% and an average degree of polymerization of 500 to 2500, is provided on at least one side of a base paper mainly made of wood pulp.

In addition, Patent Literature 2 discloses an oil-resistant paper including an oil-resistant layer containing a hydrogen-bonding resin and oil-absorbing particles on at least one side of a paper support.

Further, Patent Literature 3 discloses an oil-resistant sheet-like product including at least one coating layer containing a hydrophobized starch and a crosslinking agent on at least one side of a base material.

### CITATION LIST

### Patent Literature

Patent Literature 1: JP2004-68180A
Patent Literature 2: JP2006-183221A
Patent Literature 3: JP2010-13792A

### SUMMARY OF INVENTION

### Technical Problem

However, these techniques are still insufficient in improving oil resistance and water resistance.

An object of the present invention is to solve the above problems. Specifically, an object thereof is to provide a coating agent that provides a coating layer that is highly safe and environmentally friendly and that has excellent oil resistance and water resistance, and to provide an oil-resistant paper including at least a layer containing such a coating agent.

### Solution to Problem

As a result of extensive research in view of such circumstances, the present inventors have found that the above problems can be solved by using a composition containing a polyvinyl alcohol-based resin having a specific modification, a crosslinking agent, and a modified starch as a coating agent. Thus, the present invention has been completed.

That is, the gist of the present invention lies in a coating agent containing: a carboxy group-containing polyvinyl alcohol-based resin; a crosslinking agent; and a modified starch.

In the coating agent according to the present invention, the crosslinking agent is preferably a polyamide polyamine epihalohydrin-based resin.

In addition, the gist of the present invention lies in an oil-resistant paper including a layer containing the coating agent according to the present invention.

### Advantageous Effects of Invention

From the coating agent according to the present invention, a coating layer that is highly safe and environmentally friendly and that has excellent oil resistance and water resistance can be provided. In addition, the oil-resistant paper according to the present invention includes such a coating layer, and is thus highly safe and environmentally friendly, and has excellent oil resistance and water resistance. Therefore, the oil-resistant paper according to the present invention can be suitably used as a packaging material for packaging a material to be packaged such as foods containing an oil and fat component.

### DESCRIPTION OF EMBODIMENTS

The description of the constituent elements described below is an example (representative example) of the embodiment of the present invention, and the present invention is not limited to these contents.

Note that in the present description, a numerical range expressed using “to” means a range that includes numerical values written before and after “to” as an upper limit value and a lower limit value.

In addition, in the present description, proportions (percentages, parts, etc.) based on weight are the same as proportions (percentages, parts, etc.) based on mass.

### [Coating Agent]

A coating agent according to the present invention contains: a carboxy group-containing polyvinyl alcohol-based resin; a crosslinking agent; and a modified starch. First, the carboxy group-containing polyvinyl alcohol-based resin used in the present invention will be described.

### (Carboxy Group-Containing Polyvinyl Alcohol-Based Resin)

The carboxy group-containing polyvinyl alcohol-based resin (hereinafter, also referred to as “PVA-based resin”) used in the present invention has a structural unit having a carboxy group. Examples of a production method therefor include (1) a method of obtaining a copolymer from an unsaturated monomer having a carboxy group and a vinyl ester-based compound, and then saponifying the copolymer, and (2) a method of polymerizing a vinyl ester-based compound in the presence of an alcohol having a carboxy group or a compound having a carboxy group and a functional group such as an aldehyde or thiol as a chain transfer agent, and then saponifying the obtained polymer using a catalyst such as an alkali metal hydroxide. The method (1) is practical from the viewpoint of resin production and performance.

In the present invention, among the carboxy group-containing PVA-based resins, a maleic acid-modified PVA-based resin and an itaconic acid-modified PVA-based resin are preferred from the viewpoint of high polymerizability with a vinyl ester-based monomer, and a maleic acid-modified PVA-based resin is more preferred from the viewpoint of handling.

Hereinafter, the method (1) will be specifically described.

Examples of the above unsaturated monomer having a carboxy group include monomers such as ethylenically unsaturated dicarboxylic acids (maleic acid, fumaric acid, itaconic acid, etc.), ethylenically unsaturated carboxylic acid monoesters (maleic acid monoalkyl esters, fumaric acid monoalkyl esters, itaconic acid monoalkyl esters, etc.), ethylenically unsaturated dicarboxylic acid diesters (maleic acid dialkyl ester, fumaric acid dialkyl ester, itaconic acid dialkyl ester, etc.), ethylenically unsaturated carboxylic acid anhydrides (maleic anhydride, itaconic anhydride, etc.), or (meth)acrylic acid, and salts thereof. Ethylenically unsaturated carboxylic acid monoesters or salts thereof are preferably used.

Among these, from the viewpoint of reactivity with the vinyl ester monomer, ethylenically unsaturated carboxylic acid monoesters are preferred, maleic acid monoalkyl esters and itaconic acid monoalkyl esters are more preferred, and maleic acid monoalkyl esters are particularly preferred.

In addition, as the vinyl ester-based compound, for example, vinyl formate, vinyl acetate, vinyl propionate, vinyl butyrate, vinyl caprate, vinyl laurate, vinyl versatate, vinyl palmitate, vinyl stearate, or the like can be used alone or in combination. Vinyl acetate is particularly preferred from the viewpoint of practicality.

In the present invention, in addition to the above monomer having a carboxy group and the vinyl ester-based compound during the polymerization of the unsaturated monomer having a carboxy group and the vinyl ester-based compound, the polymerization may be carried out in the presence of a monomer copolymerizable (with vinyl ester) in an amount of 50 mol % or less, and preferably 30 mol % or less, the monomer such as allyl esters of saturated carboxylic acids (allyl stearate, allyl laurate, allyl coconut oil fatty acid, allyl octylate, allyl butyrate, etc.), α-olefins (ethylene, propylene, α-hexene, α-octene, α-decene, α-dodecene, α-hexadecene, α-octadecene, etc.), alkyl vinyl ethers (propyl vinyl ether, butyl vinyl ether, hexyl vinyl ether, octyl vinyl ether, decyl vinyl ether, dodecyl vinyl ether, tetradecyl vinyl ether, hexadecyl vinyl ether, octadecyl vinyl ether, etc.), alkyl allyl ethers (propyl allyl ether, butyl allyl ether, hexyl allyl ether, octyl allyl ether, decyl allyl ether, dodecyl allyl ether, tetradecyl allyl ether, hexadecyl allyl ether, octadecyl allyl ether, etc.), (meth)acrylamide, (meth)acrylonitrile, (meth)allylsulfonate, ethylenically unsaturated sulfonate, styrene, and vinyl chloride. There are no particular restrictions on copolymerization, and any known polymerization method may be used, and solution polymerization is usually carried out using a lower alcohol such as methanol or ethanol as a solvent.

As a method for charging the monomer in such a method, any method may used, such as a method of firstly charging the entire amount of the vinyl ester-based compound and a part of the carboxy group-containing unsaturated monomer to start the polymerization, and adding continuously or in portions the remaining unsaturated monomer during the polymerization period, and a batch charging method. The copolymerization reaction is carried out using a known radical polymerization catalyst such as azobisisobutyronitrile, acetyl peroxide, benzoyl peroxide, and lauroyl peroxide. Further, the reaction temperature is selected from a range of about 50° C. to a boiling point.

The copolymer obtained as described above is then saponified to become a carboxy group-containing PVA-based resin. In the saponification, the copolymer is dissolved in an alcohol, an acetate ester, or a mixed solvent thereof, and the saponification is carried out in the presence of an alkali catalyst. Examples of the alcohol include methanol, ethanol, and butanol, and examples of the acetate ester include methyl acetate and ethyl acetate. A concentration of the copolymer in the alcohol is preferably selected from a range 20 wt % to 50 wt %. The saponification may be carried out using, as a saponification catalyst, an alkali catalyst, for example, hydroxides and alcoholates of alkali metals such as sodium hydroxide, potassium hydroxide, sodium methylate, sodium ethylate, and potassium methylate. An amount of such a catalyst to be used is preferably 1 to 100 mmol equivalent based on the vinyl ester-based compound.

In this way, the carboxy group-containing PVA-based resin is obtained, and a content of such a carboxy group is preferably 0.1 mol % to 20 mol %, more preferably 0.5 mol % to 10 mol %, and particularly preferably 1 mol % to 3 mol %. When the content of such a carboxy group is too small, water resistance tends to decrease, and conversely, when the content is too large, coating tends to be difficult when the coating agent is used as a coating solution.

In addition, a degree of saponification (according to JIS K 6726) of the carboxy group-containing PVA-based resin is preferably 70 mol % to 100 mol %, more preferably 75 mol % to 99.9 mol %, and particularly preferably 80 mol % to 99.8 mol %. When such a degree of saponification is too small, water solubility tends to decrease.

In addition, an average degree of polymerization (according to JIS K 6726) of the carboxy group-containing PVA-based resin is preferably 200 to 4,000, more preferably 300 to 3,000, and particularly preferably 1,000 to 2,000. When such an average degree of polymerization is too large, the viscosity of the coating solution tends to increase, and when the average degree of polymerization is too small, the water resistance tends to decrease.

Examples of a form of the carboxy group-containing PVA-based resin include a powder, a granule, and a pellet, and a powder and a granule are preferred. In addition, an average particle diameter of the carboxy group-containing PVA-based resin is preferably 10 μm to 2000 μm, more preferably 30 μm to 1700 μm, and particularly preferably 50 μm to 1500 μm. When the average particle diameter is too small, particles tend to scatter and become difficult to handle, and when the average particle diameter is too large, the particles tend to have poor miscibility with the modified starch and require a long time to dissolve.

Note that the average particle diameter of the carboxy group-containing PVA-based resin in the present invention is a 50% particle diameter at which the integrated value (cumulative distribution) is 50% when a volume distribution by particle diameter is measured by a laser diffraction or sieving particle size measurement method.

### (Crosslinking Agent)

The crosslinking agent used in the present invention forms a crosslinked structure with an anion-modified PVA-based resin to become a crosslinked product, and examples thereof include an organic crosslinking agent and an inorganic crosslinking agent.

Examples of the organic crosslinking agent include: boron compounds; aldehyde compounds such as formaldehyde, acetaldehyde, glyoxal, and glutaraldehyde; amino resins such as a urea resin, a guanamine resin, and a melamine resin; epoxy-based compounds such as an epoxy resin and polyamide polyamine epihalohydrin; hydrazide-based compounds such as adipic acid dihydrazide, carbodihydrazide, and polyacrylic acid hydrazide; acid anhydrides; isocyanate compounds such as a polyisocyanate and a block isocyanate; carbodiimide-based compounds such as a polycarbodiimide resin; and oxazoline-based compounds.

Examples of the inorganic crosslinking agent include: titanium compounds such as a tetraalkoxy titanate; aluminum compounds such as aluminum sulfate, aluminum chloride, and aluminum nitrate; phosphorus compounds such as a phosphite ester and bisphenol A-modified polyphosphoric acid; modified silicones such as an alkoxy-modified silicone and a glycidyl-modified silicone; and zirconium compounds such as chlorohydroxyoxozirconium, zirconium nitrate, and zirconyl nitrate. Among these, epoxy-based compounds are preferred from the viewpoint of ease of crosslinking, and polyamide polyamine epihalohydrin is particularly preferred.

### [Polyamide Polyamine Epihalohydrin-Based Resin]

Examples of a polyamide polyamine epihalohydrin-based resin used in the present invention include polyamide polyamine epichlorohydrin, polyamide polyamine epibromohydrin, and polyamide polyamine methyl epichlorohydrin. Among these, polyamide polyamine epichlorohydrin is preferred from the viewpoint of ease of reaction.

The polyamide polyamine epihalohydrin-based resin used in the present invention can be obtained, for example, by reacting epihalohydrins with a polyamide polyamine obtained by reacting polyalkylene polyamines with dicarboxylic acids.

As the polyalkylene polyamines, those having at least 2 or more, preferably 2 to 10 alkylene groups and at least 2 or more, preferably 2 to 10 amino groups or imino groups in the molecule can be used. Examples thereof include diethylenetriamine, triethylenetetramine, and tetraethylenepentamine, and among these, diethylenetriamine is preferred. One type from these polyalkylene polyamines can be used alone or two or more types thereof can be used in combination.

In addition, instead of some of the polyalkylene polyamines, alkylene diamines such as ethylenediamine, propylene diamine or hexamethylene diamine; aminocarboxylic acids having 1 to 6 carbon atoms such as ε-aminocaproic acid; lactams of aminocarboxylic acids having 1 to 6 carbon atoms such as ε-caprolactam; or the like can be used.

As the dicarboxylic acids, those having two carboxy groups and having 3 or more carbon atoms, and preferably 3 to 30 carbon atoms in the molecule, can be used. Examples thereof include: saturated or unsaturated aliphatic dicarboxylic acids such as malonic acid, succinic acid, glutaric acid, adipic acid, pimelic acid, suberic acid, azelaic acid, sebacic acid, brassylic acid, dodecanedioic acid, itaconic acid, maleic acid, and fumaric acid; aromatic dicarboxylic acids such as phthalic acid, isophthalic acid, and terephthalic acid; acid anhydrides of the above acids; and dicarboxylic acid derivatives such as esters of each of the above acids and lower alcohols having 1 to 5 carbon atoms, especially lower alcohols having 1 to 3 carbon atoms (methyl alcohol, ethyl alcohol, and propyl alcohol). Among these, glutaric acid, adipic acid, glutaric acid methyl ester, adipic acid methyl ester and the like are preferred. One type from these dicarboxylic acids can be used alone or two or more types thereof can be used in combination.

When the polyamide polyamine is synthesized by reacting polyalkylene polyamines with dicarboxylic acids, a reaction molar ratio is preferably 0.8 mol to 1.5 mol of the polyalkylene polyamines based on 1.0 mol of the dicarboxylic acids. When an amount of such polyalkylene polyamines reacted is too large, the viscosity tends to increase, and when the amount is too small, an amount of the polyamide polyamine generated tends to decrease.

The reaction between the polyalkylene polyamines and the dicarboxylic acids is preferably continued until the generated polyamide polyamine has a viscosity within a range of 100 mPa·s to 1000 mPa·s based on a viscosity at 25° C. of an aqueous solution having a solid content of 50 wt %.

When the amino group in the polyalkylene polyamines is reacted with the carboxy groups in the dicarboxylic acids, dehydration and/or dealcoholization is carried out by using reaction heat generated during charging raw materials or by performing heating from the outside. The reaction temperature depends on whether the dicarboxylic acids are free acids or derivatives such as an anhydride or an ester, and is preferably 110° C. to 250° C., and more preferably 120° C. to 180° C. At this time, as a catalyst for a polycondensation reaction, for example, sulfonic acids such as sulfuric acid, benzenesulfonic acid, and para-toluenesulfonic acid, phosphoric acids such as phosphoric acid, phosphonic acid, and hypophosphorous acid, and other known catalysts can be used alone or in combination of two or more thereof. An amount to be used is preferably 0.005 mol to 0.1 mol, particularly preferably 0.01 mol to 0.05 mol, based on 1 mol of the polyalkylene polyamines.

The polyamide polyamine epihalohydrin-based resin used in the present invention can be obtained by reacting the above polyamide polyamine with epihalohydrins.

Examples of the epihalohydrins include an epihalohydrin and an epihalohydrin having an alkyl group or an alkylene group having 1 to 10 carbon atoms. Examples of the halogen in the epihalohydrin include chlorine, bromine, and iodine. Specific examples thereof include epichlorohydrin, epibromohydrin, and methyl epichlorohydrin. Two or more types of these can also be mixed and used. Among these epihalohydrins, epichlorohydrin is particularly preferred.

A reaction ratio of the epihalohydrins to the polyamide polyamine is preferably 0.01 mol to 2.0 mol, particularly preferably 0.05 mol to 1.5 mol, and still more preferably 0.05 mol to 1 mol, based on 1 mol of the amino group in the polyamide polyamine. When the molar ratio of the epihalohydrins is too large, an amount of a low-molecular organic halogen compound generated as a by-product of the epihalohydrins tends to increase. When the molar ratio of the epihalohydrins is too small, the water resistance of the obtained resin tends to decrease.

The reaction between the polyamide polyamine and the epihalohydrins is preferably carried out at a reaction solution concentration of 15 wt % to 80 wt % in terms of solid content and a reaction temperature of 5° C. to 90° C. Particularly, in order to increase reaction efficiency of the polyamide polyamine with the epihalohydrins, it is preferable that the temperature when adding the epihalohydrins to the polyamide polyamine is in a range of 5° C. to 45° C., in the subsequent reaction, the temperature is set at 45° C. to 90° C., and the obtained polyamide polyamine epihalohydrin-based resin is increased in molecular weight to obtain a predetermined viscosity.

During the reaction between the polyamide polyamine and the epihalohydrins, by continuing the reaction until the obtained polyamide polyamine epihalohydrin-based resin has a viscosity in a range of preferably 10 mPa·s to 100 mPa·s, and particularly preferably 15 mPa·s to 80 mPa·s, based on a viscosity at 25° C. of an aqueous solution having a solid content of 15 wt %, a resin having excellent water resistance can be obtained. After the viscosity of the reaction solution falls within this viscosity range, water is added to the reaction solution and the reaction solution is cooled to stop the reaction, thereby obtaining an aqueous solution of the polyamide polyamine epihalohydrin-based resin.

A weight average molecular weight of the polyamide polyamine epihalohydrin-based resin used in the present invention is preferably 500 to 30,000, more preferably 800 to 20,000, and particularly preferably 1,000 to 10,000. When such a weight average molecular weight is too large, the viscosity tends to increase and workability tends to decrease, and when the weight average molecular weight is too small, the water resistance tends to decrease.

Note that the weight average molecular weight of the polyamide polyamine epihalohydrin-based resin is measured by a gel permeation chromatography (GPC) method.

In the coating agent according to the present invention, a content of the crosslinking agent is preferably 0.1 to 50 parts by weight, more preferably 1 to 40 parts by weight, and still more preferably 5 to 30 parts by weight, based on 100 parts by weight of the carboxy group-containing PVA-based resin. When the content of such a crosslinking agent is too large, the viscosity tends to increase and viscosity stability of a coating solution tends to decrease, and when the content is too small, the water resistance tends to decrease.

### (Modified Starch)

Examples of the modified starch used in the present invention include: physically modified starches such as α-starch, fractionated amylose, a moist heat treated starch, and a thermochemically modified starch; enzymatically modified starch such as hydrolyzed dextrin, enzymatically degraded dextrin, and amylose; oxidized starches such as an acid-treated starch and a hypochlorite oxidized starch; chemically decomposed modified starches such as a dialdehyde starch; and chemically modified starch derivatives such as an esterified starch, an etherified starch, a cationized starch, and a crosslinked starch.

Note that examples of the esterified starch among the chemically modified starch derivatives include an acetate esterified starch, a succinate esterified starch, a nitrate esterified starch, a phosphate esterified starch, a urea phosphate esterified starch, a xanthate esterified starch, an acetoacetate esterified starch, and a carbamate esterified starch. Examples of the etherified starch include an allyl etherified starch, a methyl etherified starch, a carboxy etherified starch, a carboxymethyl etherified starch, a hydroxyethyl etherified starch, and a hydroxypropyl etherified starch. Examples of the crosslinked starch include a formaldehyde crosslinked starch, an epichlorohydrin crosslinked starch, a phosphoric acid crosslinked starch, and an acrolein crosslinked starch.

Among these, an etherified starch is practical from the viewpoint of compatibility with the carboxy group-containing PVA-based resin. The modified starch used in the present invention may be partially crosslinked.

One type selected from these modified starches can be used alone or two or more types thereof can be used in combination.

An average particle diameter of the modified starch is preferably 0.1 μm to 200 μm, particularly preferably 1 μm to 150 μm, and still more preferably 3 μm to 100 μm. The average particle diameter of a polysaccharide is a value measured using a laser diffraction particle size distribution measuring device applying a light scattering theory for an aqueous dispersion of the polysaccharide.

In the coating agent according to the present invention, a content of the modified starch is preferably 1 to 1000 parts by weight, more preferably 5 to 800 parts by weight, and still more preferably 10 to 500 parts by weight, based on 100 parts by weight of the carboxy group-containing PVA-based resin. When the content of such a modified starch is too large, the water resistance tends to decrease, and when the content is too small, the crosslinking is easier and the viscosity stability of the coating solution tends to decrease.

### (Other Additives)

The coating agent according to the present invention may contain various additives such as an inorganic layered compound, other water-insoluble resins, a pigment, a dispersant, a thickener, a water retention agent, and an antifoaming agent, if necessary. The content of these additives is preferably 30 wt % or less, particularly preferably 10 wt % or less, and still more preferably 5 wt % or less, based on a total solid content weight of the coating agent.

Examples of the inorganic layered compound that can be contained in the coating agent according to the present invention include clay minerals such as natural mica, synthetic mica, smectite, and montmorillonite, and synthetic smectite.

When the coating agent according to the present invention contains the inorganic layered compound, the oil resistance and the water resistance of the coating layer can be further improved.

The other water-insoluble resins that can be contained in the coating agent according to the present invention is preferably a water-insoluble resin having a glass transition temperature of 50° C. or lower, and examples thereof include an acrylic resin, a polyester-based resin, a polyurethane-based resin, a styrene-butadiene copolymer resin, a styrene-acrylic resin, an ethylene-vinyl acetate-based resin, an acrylonitrile-butadiene-based resin, a polyethylene-based resin, a polypropylene-based resin, a carboxymethyl cellulose-based resin, a polyethylene terephthalate-based resin, a polyamide-based resin, vinyl chloride-based resin, a vinylidene chloride-based resin, a silicone-based resin, a mixture of an acrylic resin and a wax, and a mixture of a styrene-acrylic resin and a wax. Among these, a styrene-butadiene copolymer resin or an acrylic resin is preferably used. In addition, the coating agent according to the present invention may contain a styrene-butadiene rubber.

When the coating agent according to the present invention contains the water-insoluble resin, excellent water resistance can be exhibited.

Examples of the pigment that can be contained in the coating agent according to the present invention include various pigments such as an inorganic pigment and an organic pigment. Specific examples of the inorganic pigment include minerals such as kaolin, structural kaolin, delaminated kaolin, calcined kaolin, synthetic mica, heavy calcium carbonate, light calcium carbonate, talc, calcium sulfate, barium sulfate, titanium dioxide, zinc oxide, alumina, aluminum hydroxide, magnesium carbonate, magnesium oxide, silica, magnesium aluminosilicate, calcium silicate, white carbon, bentonite, zeolite, sericite, and smectite. Among these, kaolin is preferably used because of exhibiting excellent oil resistance and water resistance. Specific examples of the organic pigment include solid, hollow, or through-hole particles, and examples thereof include: polydienes such as polyisoprene, polyneoprene, and polybutadiene; polyalkenes such as polybutene, polyisobutylene, and polypropylene; vinyl acetate; styrene; (meth)acrylic acid; (meth)acrylic acid alkyl esters; (meth)acrylamides; polymers and copolymers of vinyl-based monomers such as methyl vinyl ether; polyurethane-based resins; polyester-based resins; polyamide-based resins; urea-based resins; melamine-based resins; and benzoguanamine-based resins.

One type selected from these pigments can be used alone or two or more types thereof can be used in combination.

### (Preparation of Coating Agent)

The coating agent according to the present invention can be prepared by mixing and stirring the above components, and can be obtained as a fluid powder mixture, solution, suspension, or the like. For example, a carboxy group-containing PVA-based resin solution having a concentration of 1 wt % to 30 wt %, a crosslinking agent solution having a concentration of 1 wt % to 30 wt %, and a modified starch dispersion solution having a concentration of 1 wt % to 30 wt % are mixed and other components are mixed if necessary, to obtain the coating agent according to the present invention.

The stirring can be carried out by appropriately selecting various stirring devices such as a propeller mixer, a planetary mixer, a hybrid mixer, a kneader, an emulsifying homogenizer, and an ultrasonic homogenizer. In addition, the stirring can be carried out during heating or cooling, if necessary.

### [Oil-Resistant Paper]

An oil-resistant paper according to the present invention is an oil-resistant paper including a layer containing the coating agent according to the present invention, and includes a layer containing the coating agent (coating layer) on at least one side of a paper base material.

### (Paper Base Material)

The paper base material to be coated with the coating agent according to the present invention is not particularly limited. Examples thereof include a high-quality paper, a medium-quality paper, a coated paper, a lightly coated paper, a glassine paper, an unbleached or bleached kraft paper (an acidic paper or a neutral paper), a single-gloss paper, a kraft paper, a paperboard (for cardboard, building materials, white cardboard, chipboard, etc.), a white paperboard, and a manila lined board, which have a basis weight of about 30 g/m² to 500 g/m². Note that the paper base material may contain additives such as a sizing agent and aluminum sulfate.

As pulp constituting the paper base material, any pulp commonly used for papermaking can be used. For example, chemical pulp such as leaf bleached kraft pulp (LBKP), needle bleached kraft pulp (NBKP), leaf bleached sulfite pulp (LBSP), and needle bleached sulfite pulp (NBSP); and mechanical pulp such as ground wood pulp (GP) and thermomechanical pulp (TMP) can be used. Further, non-wood pulp such as cotton, cotton linters, hemp, bagasse, kenaf, esparto, kozo, mitsumata, and gampi; synthetic fibers such as synthetic pulp, polyethylene, and polypropylene; and inorganic fibers can also be used in combination if necessary.

A thickness of the paper base material is preferably 30 μm or more, and particularly preferably 40 μm or more. In addition, the thickness of the paper base material is preferably 500 μm or less, and particularly preferably 300 μm or less. By setting the thickness of the base material within the above range, appropriate strength can be obtained and coating suitability of the coating agent is improved.

The paper base material may further contain an additive. Examples of such an additive include various additives, for example, sizing agents such as rosin, alkyl ketene dimer, and alkenyl succinic acid; fixing agents such as aluminum sulfate and a cationic polymer electrolyte; fillers such as clay, talc, calcium carbonate, calcined kaolin, aluminum oxide, aluminum hydroxide, titanium oxide, amorphous silica, and urea-formalin resin particles; paper strength agents such as a polyacrylamide polymer and a starch; wet paper strength agents such as a melamine resin, a urea resin, and a polyamide polyamine epichlorohydrin resin; water filtering agents; dyes for color adjustment such as a bluing; and a fluorescent dye.

### (Production of Paper Base Material)

The paper base material can be obtained by making a paper using various paper machines in a common manner to form a wet paper and then drying the wet paper. Note that the paper base material can contain a starch, polyvinyl alcohol, gelatin, a filler, or the like, if necessary, and can be produced through common treatment steps such as a surface size press treatment and a smoothing treatment using a machine calender.

Examples of the paper machine to be used include a Fourdrinier paper machine having an air cushion head box or a hydraulic head box, a twin wire paper machine, an on-top twin wire paper machine, and a Yankee paper machine.

### (Production of Oil-Resistant Paper)

The oil-resistant paper according to the present invention can be produced, for example, by coating at least one side of the paper base material with a coating solution containing the coating agent according to the present invention and drying the coating solution.

A coating method with the coating solution is not particularly limited, and for example, an applicator, a blade coater, an air knife coater, a roll coater, a reverse roll coater, a bar coater, a curtain coater, a slot die coater, a gravure coater, a champlex coater, a brush coater, a slide bead coater, a two-roll or rod metering size press coater, a bill rod metering size press coater, a short dwell coater, a gate roll coater, and a nip coater using a calender are used as appropriate. Among these, in order to increase production efficiency, it is preferable to use a bar coater, a blade coater, or a rod metering size press coater, and it is particularly preferable to use a rod metering size press coater.

A coating amount (after drying) of the coating layer is preferably 0.1 g/m² to 20 g/m², and particularly preferably 0.5 g/m² to 15 g/m². By setting the coating amount of the coating layer within the above range, an oil-resistant layer that can exhibit sufficient oil resistance performance can be obtained.

In the present invention, only one coating layer may be provided on at least one side of the paper base material, but a plurality of coating layers may be provided on at least one side of the base material. In addition, the coating layer may be provided on both sides of the paper base material.

After coating one side of the base material with the coating agent, a step of drying the coating agent is provided. In addition, in the present invention, after forming the coating layer, a smoothing treatment may be performed if necessary. The smoothing treatment is performed on-machine or off-machine using a general smoothing treatment device such as a super calender, a gloss calender, or a soft calender.

The oil-resistant paper according to the present invention is highly safe and environmentally friendly and has excellent oil resistance and water resistance, and can thus be suitably used as a packaging material for packaging a material to be packaged such as foods containing an oil and fat component. The oil-resistant paper according to the present invention further has excellent heat resistance and does not lose oil resistance even when heated, for example, in an oven, and can thus be suitably used for a packaging material that requires heat resistance and oil resistance.

### EXAMPLES

Hereinafter, the present invention will be described in more detail using Examples, but the present invention is not limited to the following Examples unless it departs from the gist thereof.

Note that, in Examples and Comparative Examples, “part” and “%” are based on weight.

In addition, a 4% viscosity and an average degree of saponification of the carboxy group-containing PVA-based resin in the following Examples and Comparative Examples were measured according to the methods described above.

### [Production of Carboxy Group-Containing PVA1 (PVA1)]

To a reaction vessel equipped with a reflux condenser, a dropping funnel, and a stirrer, 100 parts of vinyl acetate, 26 parts of methanol, and 0.1 parts (0.09 mol % based on a total amount of vinyl acetate) of monomethyl maleate were charged, the temperature was raised to 60° C. under a nitrogen stream while stirring, and then 0.001 mol % (based on the total amount of vinyl acetate) of t-butyl peroxyneodecanoate (temperature at a half-life of 1 hour was 65° C.) was charged as a polymerization catalyst to initiate polymerization. Immediately after the start of the polymerization, 2 parts (2 mol % based on the total amount of vinyl acetate) of monomethyl maleate and 0.008 mol % (based on the total amount of vinyl acetate) of t-butyl peroxyneodecanoate were added continuously according to a polymerization speed, and when a polymerization rate of vinyl acetate reached 73%, 0.01 parts of 4-methoxyphenol and 58 parts of methanol for dilution and cooling were added to complete the polymerization.

Subsequently, the unreacted vinyl acetate monomer was removed from the system by blowing methanol vapor to obtain a methanol solution of a copolymer.

Next, the solution was diluted with methanol to adjust the concentration to 40%, a 4% methanol solution of sodium hydroxide was mixed thereto at a proportion of 30 mmol based on 1 mol of vinyl acetate structural units in the copolymer, and a saponification reaction was carried out at a temperature of 40° C. to 50° C. The resin solidified by the saponification reaction was cut and dried at 70° C. to obtain PVA1 shown in Table 1 (4% viscosity: 31.6 mPa·s, average degree of saponification: 94.5 mol %).

### [Production of Carboxy Group-Containing PVA2 (PVA2)]

PVA2 shown in Table 1 was obtained in the same manner as in the production of the above PVA1, except that a final degree of saponification was changed (4% viscosity: 28.3 mPa·s, average degree of saponification: 99.2 mol %). In addition, PVA1 and PVA2 shown in Table 1 were used in the following Examples and Comparative Examples.

TABLE 1

| | Modification | Average degree of | |
|---|---|---|---|
| Carboxy group- | amount | saponification | 4% viscosity |
| containing PVA | (mol %) | (mol %) | (mPa · s) |
| PVA1 | 2 | 94.5 | 31.6 |
| PVA2 | 2 | 99.2 | 28.3 |

### Example 1

### Preparation of Oil Resistance and Water Resistance Evaluation Sample

To 100 parts by weight of a solution obtained by mixing a 10% aqueous dispersion solution of a hydroxyethyl etherified starch (“Penford gum 380” manufactured by Ingredion) and a 10% aqueous solution of PVA1 at a mixing ratio of 7/3 was added 6 parts by weight of a 10% aqueous solution of a polyamide polyamine epichlorohydrin resin as a crosslinking agent, and a commercially available copy paper (OST Clean Copy, basis weight: 64 g/m²) was coated with the mixed solution obtained by mixing with a 50 μm applicator, followed by drying at 105° C. for 5 minutes to form a coating layer having a thickness of 2.5 μm, thereby preparing an oil resistance evaluation sample.

### Oil Resistance Evaluation (Kit Test)

With reference to the Kit test in J. TAPPI No. 41, a Kit reagent, which is a mixture of three types of oils at a predetermined ratio, was dropped onto the sample surface of the sample prepared above, and the presence or absence of seepage after 15 seconds was evaluated using the Kit reagent number according to the evaluation criteria below. The results are shown in Table 3.
10 to 12: A (excellent)
7 to 9: B (good)
4 to 6: C (acceptable)
0 to 3: D (unacceptable)

### Water Resistance Evaluation (Cobb Test)

The sample prepared above was evaluated using the Cobb test method specified in JIS P8140. The sample was attached to a support, distilled water at 20° C. was poured into the sample, and the amount of water absorbed per 1 m² was measured after one minute. The results are shown in Table 3.
20 g/m² or less: A (excellent)
21 g/m² to 22 g/m²: B (good)
23 g/m² to 25 g/m²: C (acceptable)
26 g/m² or more: D (unacceptable)

### Examples 2 to 9 and Comparative Examples 1 to 3

The oil resistance and the water resistance were evaluated in the same manner as in Example 1, except that the types and amounts of the carboxy group-containing PVA, the crosslinking agent, and the modified starch were changed as shown in Table 2 and Table 3. The results are shown in Table 3.

TABLE 2

| Starch | Hydroxyethyl | “Penford gum 380” manufactured by |
|---|---|---|
| 1 | etherified starch 1 | Ingredion |
| Starch | Hydroxypropyl | “Matsuya Yuri” manufactured by |
| 2 | etherified starch 1 | Matsutani Chemical Industry Co., Ltd. |
| Starch | Hydroxyethyl | “Ulstar E” manufactured by NIHON |
| 3 | etherified starch 2 | SHOKUHIN KAKO CO., LTD. |
| Starch | Hydroxypropyl | “Matsuya Marigold” manufactured by |
| 4 | etherified starch 2 | Matsutani Chemical Industry Co., Ltd. |
| Starch | Hydroxypropyl | “Food starch SG” manufactured by |
| 5 | etherified starch 3 | Matsutani Chemical Industry Co., Ltd. |
| Starch | Unmodified starch | “Cornstarch Y” manufactured by NIHON |
| 6 | | SHOKUHIN KAKO CO., LTD. |

TABLE 3

| | Carboxy group- | | Crosslinking | | | Oil | Water |
|---|---|---|---|---|---|---|---|
| | containing PVA | | agent | Modified starch | | resistance | resistance |
| | Type | Part by mass | Part by mass | Type | Part by mass | evaluation | evaluation |
| Example 1 | PVA1 | 30 | 6 | Starch 1 | 70 | A (12) | A (17) |
| Example 2 | PVA1 | 50 | 10 | Starch 2 | 50 | A (12) | A (19) |
| Example 3 | PVA1 | 30 | 6 | Starch 3 | 70 | A (12) | A (20) |
| Example 4 | PVA1 | 30 | 6 | Starch 4 | 70 | A (11) | B (21) |
| Example 5 | PVA2 | 30 | 6 | Starch 2 | 70 | A (10) | B (21) |
| Example 6 | PVA2 | 50 | 10 | Starch 2 | 50 | A (11) | A (18) |
| Example 7 | PVA1 | 50 | 10 | Starch 1 | 50 | A (12) | A (18) |
| Example 8 | PVA1 | 30 | 6 | Starch 2 | 70 | A (12) | B (21) |
| Example 9 | PVA1 | 50 | 10 | Starch 5 | 50 | A (12) | B (21) |
| Comparative | PVA1 | 30 | 6 | Starch 6 | 70 | D (2) | A (16) |
| Example 1 | | | | | | | |
| Comparative | PVA1 | 30 | — | Starch 2 | 70 | A (12) | D (28) |
| Example 2 | | | | | | | |
| Comparative | — | — | | Starch 1 | 100 | D (2) | A (18) |
| Example 3 | | | | | | | |

As shown in Table 3, the oil-resistant papers including a layer (coating layer) containing the coating agent according to the present invention (Examples 1 to 9) have excellent oil resistance as compared with Comparative Example 1 which does not contain the modified starch specified in the present invention (containing an unmodified starch) and Comparative Example 3 which does not contain the carboxy group-containing PVA specified in the present invention, and have excellent water resistance as compared with Comparative Example 2 which does not contain the crosslinking agent specified in the present invention. Note that the coating agent according to the present invention does not contain fluorine compounds, and is thus highly safe and environmentally friendly.

Although various embodiments have been described above with reference to the drawings, it goes without saying that the present invention is not limited to such examples. It is clear that those skilled in the art can come up with various changes or modifications within the scope of the claims, and it is understood that these also naturally fall within the technical scope of the present invention. In addition, each of the constituent elements in the above embodiments may be freely combined without departing from the spirit of the invention.

Note that the present application is based on Japanese patent application No. 2021-052050 filed on Mar. 25, 2021, the content of which is incorporated by reference into the present application.

### INDUSTRIAL APPLICABILITY

The coating agent according to the present invention can be suitably used for an oil-resistant paper used as a packaging material for foods containing an oil and fat component. In addition, the oil-resistant paper according to the present invention can be used as a packaging paper, a container, and a base paper for decorative boards for packaging or wrapping foods containing an oil and fat component, for example, fast foods such as hamburgers, french fries, and fried chicken; side dishes such as tempura, pork cutlet, and salad; and sweets such as chocolate, pizza, and donuts.

1. A coating agent comprising: a carboxy group-containing polyvinyl alcohol-based resin; a crosslinking agent; and a modified starch.

2. The coating agent according to claim 1, wherein the crosslinking agent is a polyamide polyamine epihalohydrin-based resin.

3. The coating agent according to claim 1, wherein the modified starch is an etherified starch.

4. The coating agent according to claim 1, wherein the crosslinking agent is contained in an amount of 0.1 to 50 parts by weight based on 100 parts by weight of the carboxy group-containing polyvinyl alcohol-based resin.

5. The coating agent according to claim 1, wherein the modified starch is contained in an amount of 1 to 1000 parts by weight based on 100 parts by weight of the carboxy group-containing polyvinyl alcohol-based resin.

6. An oil-resistant paper comprising: a layer containing the coating agent according to claim 1.
